(19) United States
(12) Patent Application Publication
(10) Pub. No.: US 2005/0091058 A1
(43) Pub. Date: Apr. 28, 2005

(54) Interactive telephone voice services

(75) Inventors: Laurent Biettron, Lannion (FR); Benedicte Cherbonnel, Saint Quay Perros (FR); Paul Miquel, Perros Quirec (FR); Frederick Pallu, Trebeurden (FR)

Correspondence Address: LOWE HAUPTMAN GILMAN AND BERNER, LLP, 1700 DIAGONAL ROAD, SUITE 300 /310, ALEXANDRIA, VA, 22314, US

(73) Assignee: france telecom, paris (FR)

(21) Appl. No.: 10/504,578

(22) PCT Filed: Dec. 19, 2002
(86) PCT No.: PCT/FR02/04444

(30) Foreign Application Priority Data
Feb. 13, 2002 (FR) 02/01878

(51) Int. Cl. G10L 11/00

(52) U.S. Cl. 704/270.1

(57) ABSTRACT

In order to navigate in interactive voice services (PSV) implemented on a platform and accessible from a user terminal (TU) and executed in a first language in an interactive voice server (SVI), e.g., VXML, the voice services include identifiers of other voice services or of portions thereof, which in turn include returns to the voice services. In the platform (PSV) the description of a voice service from an administrator terminal (TA) is written in a high-level language of the invention which is converted into the first language during the service call so as to be executed in the voice server. Thus, the invention networks voice services while facilitating publishing thereof.

The present invention relates to access to telephone voice services, especially for publishing them and consulting them.

Until now, developing voice applications has been a matter for voice system experts. Techniques and the means for implementing them have consisted of proprietary solutions. The services have therefore not been portable.

With the emergence of XML (extensible Markup Language), generic high-level languages have appeared in various scientific or industrial fields, for example mathematics: MathML (Mathematical Markup Language), astronomy: AIML (Astronomical Instrument Markup Language), and chemistry: CML (Chemical Markup Language). These languages, based on HTML but modifying the form thereof, are used in particular fields to develop generic systems for broadcasting documents over the Internet.

VXML (Voice extensible Markup Language) language, as defined by the VoiceXML Forum, has emerged in a similar way in the voice field. VXML language is used to program voice dialog using voice synthesis, audio files, voice recognition and input via a telephone keypad. VXML language is also used to record voice input and for alphanumeric input via the telephone keypad. The primary object of VXML language is to interconnect the world of the Web and that of fixed or mobile telephones.

A voice platform comprises an HTTP (HyperText Transfer Protocol) client recovering VXML pages, a VXML interpreter, voice synthesis and recognition engines, an audio stream or keypad input reader, and telephone transceiver means. The VXML pages are delivered by application servers such as conventional HTTP servers in the form of static files defined either once and for all or dynamically by means of CGI scripts or Java applets, for example, able to recover data from a database.

The telephone is still the most widespread and most widely used means of accessing information. It is almost always possible to obtain access to a telephone anywhere and anytime. The Internet necessitates more complex tools and is not accessible the whole of the population. The easier it is to make information available on the Internet, the more complex it becomes to access it by telephone, i.e. by vocal transmission of the information.

According to a first example, a sports club may require to offer its members access to rapidly changing information, such as details of impending sports events. The club's members, not all of whom have access to the Internet, must be able to access the information at the last possible moment. The club manager does not wish to call or to be called by each individual member. Voice messaging to broadcast the information offers only a partial solution to this problem. Voice messaging merely broadcasts a voice message and does not constitute a true interactive voice service offering varied voice and text information and a browser for accessing the data.

At present, there is no generic solution to this type of problem.

A second example relates to an Internet information provider. Given fixed subscription and hosting costs, the provider's potential telephone audience is not sufficient for the provider to invest in the development and hosting of interactive voice access to his services. The site's proprietor would undoubtedly be inclined to make the information available via telephone if that solution were systematically cost effective and easy to implement.

A third example relates to a person who regularly consults voice services relating to the weather, astrology, stock market prices, etc., for example. This person must call each of these services separately. Browsing within a voice service is specific to the service, with or without voice recognition, and depends on a predetermined cancel key, etc.

It is not possible for all these persons to create for themselves their own voice services comprising services that interest them and only those services. For example, if a person accesses a list of television programmes, the list should contain only programmes on TV channels that the person is able to receive.

At present, users can personalize the services of a web portal to access only web services of interest to them. Also, a user may create his own web pages, for example using model pages. Moreover, hyperlinks enable browsing within and between existing services. If publication of data via the Internet and by telephone are compared, the possibilities of constructing interactive voice services by telephone are seen to be much more limited.

To construct a voice service, it is necessary to be highly skilled in data processing and to have access to a voice platform connected to the telephone network.

Two solutions may be envisaged. The first consists in accessing a voice server and developing a particular service in a proprietary language depending on the voice platform. This first solution could be replaced by a second solution based on VXML, which is a structured abstract language that an increasing number of voice platforms are able to interpret. The benefit of the second solution lies in the normalized character of VXML and in the possibility of transposing a service from one voice platform to another.

An object of the invention is to provide interactivity between voice services that offer varied information and are published and implemented independently of each other, as easily as creating web pages on the Internet.

Accordingly, a method for accessing from a user terminal interactive voice services executed in a first language in an interactive voice server, is characterized in that it comprises in a platform communicating with the vocal server,
networking voice services written in a second language by means of identifiers included in voice services and relating to portions of other voice services and by means of returns to said voice services respectively included in said portions of other voice services, and
converting from the second language into the first language, in the platform, any voice service called up from the terminal via the voice server in order to transmit the voice service converted into the first language from the platform to the voice server for execution therein, and any portion of another voice service identified in said voice service and called up during the execution of said voice service in order to transmit the voice service portion converted into the first language from the platform to the voice server for execution therein.

Thanks to the links between voice services consisting of the identifier/return pairs, the invention networks voice services that dynamically share certain portions, and therefore enables browsing between the voice services. A voice service of the invention may provide access to other voice services and/or to portions of other voice services also published in accordance with the invention. In the following description, references to a “portion” of a voice service may also refer to the voice service itself.

Instead of all the voice services being implemented on a platform, they can be implemented on a plurality of platforms, two platforms communicating with each other if at least a portion of a service on one of them is identified and called up by another service on the other platform.

The voice services are written in a second high-level language different from the first language in which a voice service is executed in the voice server. The portion of another voice service called from the calling voice service is launched after being converted from the second language into the first language on the platform.

The second language is specific to the invention and the first language is VXML language, for example, which is compatible with the interactive voice server. The second language facilitates, for a non-expert user, the definition, for example via a web interface, of a tree-structured interactive voice service, the introduction of diverse attributes governing in particular access to services and portions of voice services and their periods of validity, and error control.

The characteristics of the first language correspond to the requirements of voice services broadcasting information, such as services broadcasting information by diverse means, for example listening to sound files or to voice synthesized from text, and recording audio messages via the telephone for voice service administrators. The service implemented automatically in the first language on the platform interpreting that language may be used by the publisher of the service and/or a community such as a sports club, an association, a profession or the general public.

For example, the method of the invention may comprise, during publishing at a voice service administrator terminal or during modification of a voice service already made available to the public and accessible from user terminals,
introducing from an administrator terminal into a voice service in the second language an attribute for authorizing or prohibiting calling up the voice service or a portion of the voice service from within another voice service
introducing the identifier of another service or of a portion of another service, including an address of the other service or of the portion of the other voice service, into a voice service written in the second language where applicable in another platform, for example the portion of service being a submenu, a set or choice of submenus,
introducing the identifier of a text file to be synthesized from an administrator terminal into a voice file in the interactive voice server, or a sound file entered or read in the administrator terminal, into a voice service in the second language in order to store the file on the platform,
introducing from an administrator terminal into a voice service in the second language an address of a text file to be synthesized in the form of a voice file in the voice server or the address of a sound file, the text or sound file being available on a remote other platform,
a supplying to the platform from an administrator terminal a summary of a vocal or textual voice service to be synthesized subsequently,
introducing into the first voice service start and end of validity dates between which or at least one validity date during which data of the first voice service is accessible on the platform to the user terminal via a voice server,
or introducing an access secret code and/or a list of user terminal identifiers in corresponding relationship to the identifier of a voice service.

The invention relates also to an interactive voice services system carrying out the method of the invention, wherein a user terminal accesses voice services executed in a first language in an interactive voice server. The system is characterized in that it comprises a first platform and an administrator terminal for publishing an interactive voice service accessible from the user terminal via the interactive voice server on a second platform,
the first platform networking voice services written in a second language by means of identifiers included in voice services and relating to portions of other voice services and by means of returns to said voice services respectively included in said portions of other voice services, and
the second platform converting from the second language into the first language any voice service called up from the terminal via the voice server in order to transmit the voice service converted into the first language from the second platform to the voice server for execution therein, and any portion of another voice service identified in said voice service and called up during the execution of said voice service in order to transmit the voice service portion converted into the first language from the second platform to the voice server for execution therein. Preferably, the first and second platforms are combined in one and the same platform.

The system of the invention is based on the second high-level language specific to the invention used to describe a voice service. Using this language guarantees:
the creation of a voice service and access via the telephone to the service created by means of the platform,
browsing between all elements of the service, and
setting up a real network of voice services described in the second language.

Other features and advantages of the present invention will become more clearly apparent on reading the following description of several preferred embodiments of the invention, which description is given with reference to the corresponding appended drawings, in which:

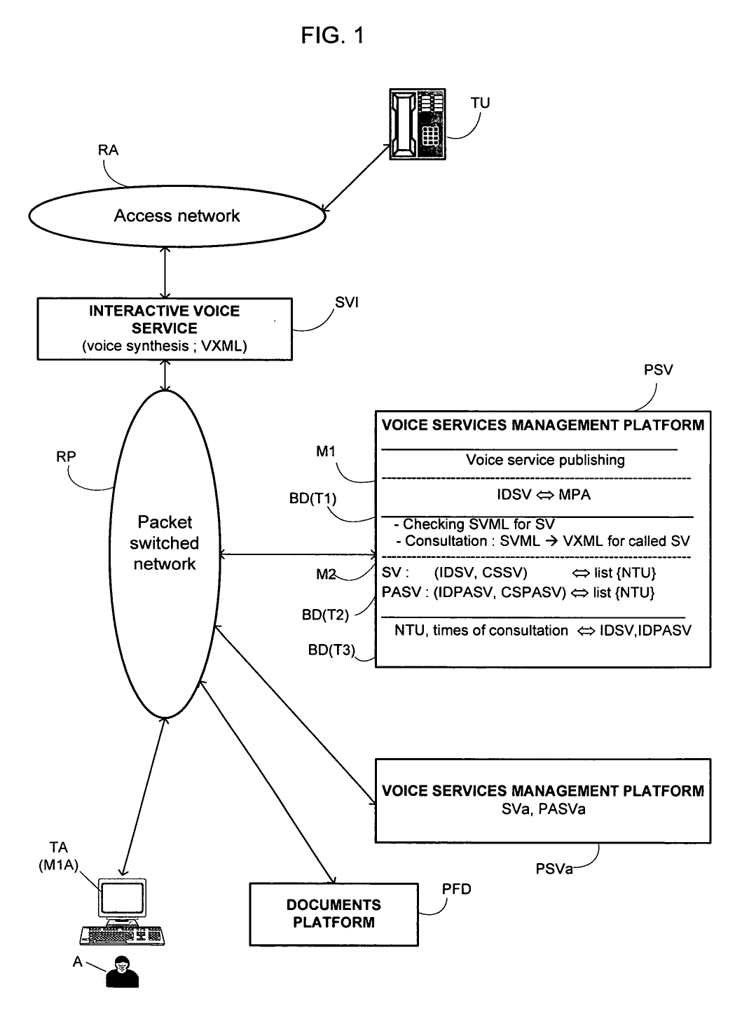

FIG. 1 is a block diagram of a system of the invention for creating and browsing interactive telephone voice services;

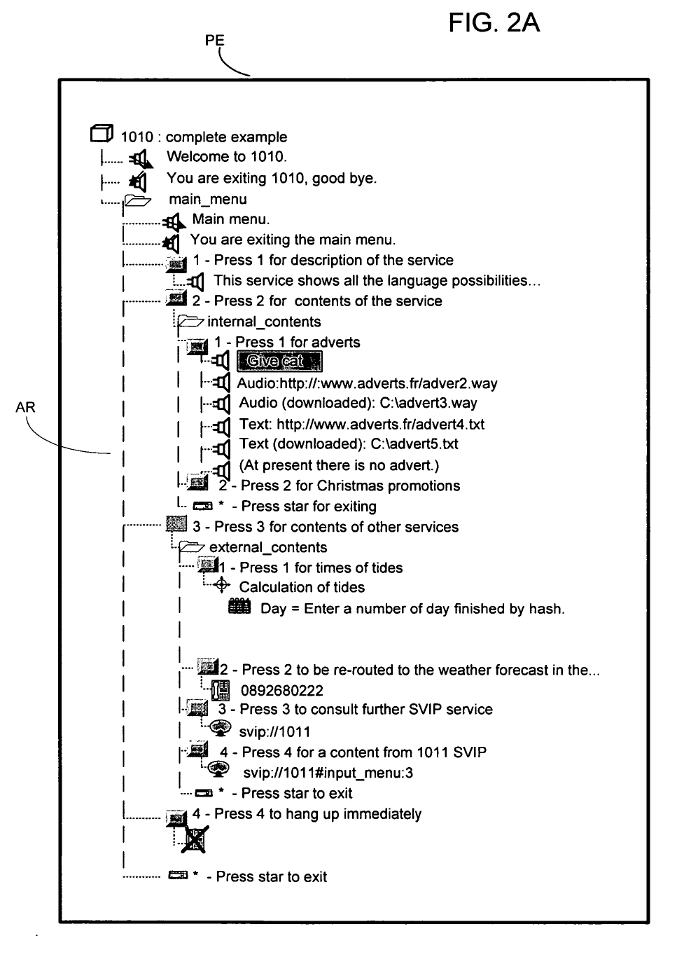

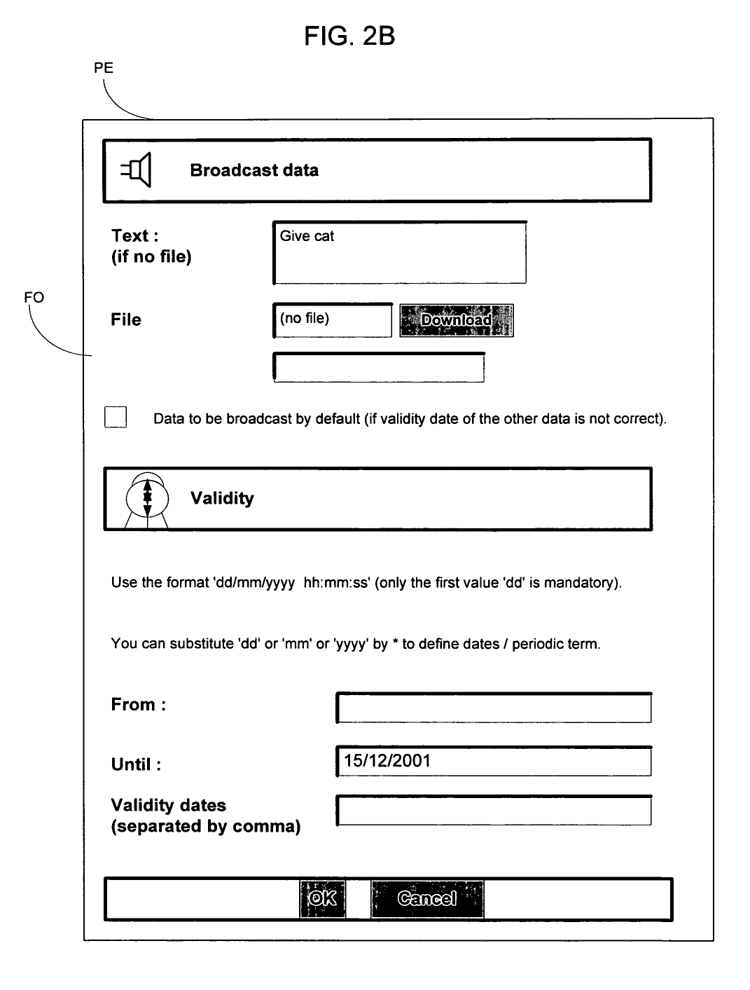

FIGS. 2A and 2B represent left-hand and right-hand portions of a screen page displayed on an administrator terminal during the creation of a voice service;

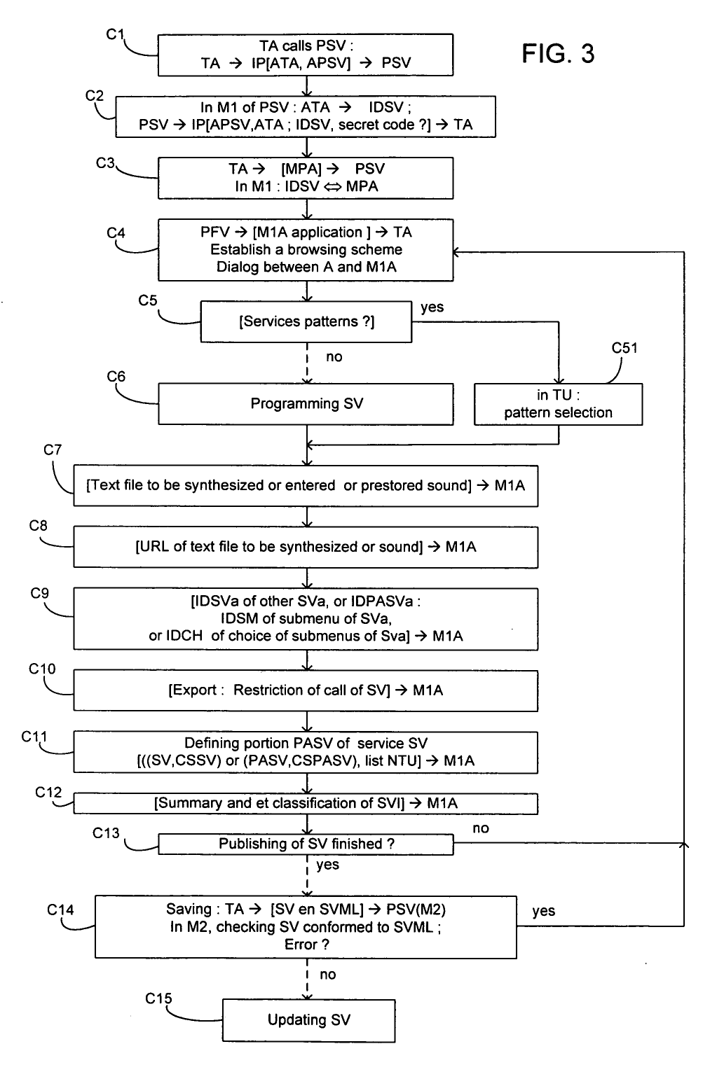

FIG. 3 depicts a voice service publishing algorithm of the invention;

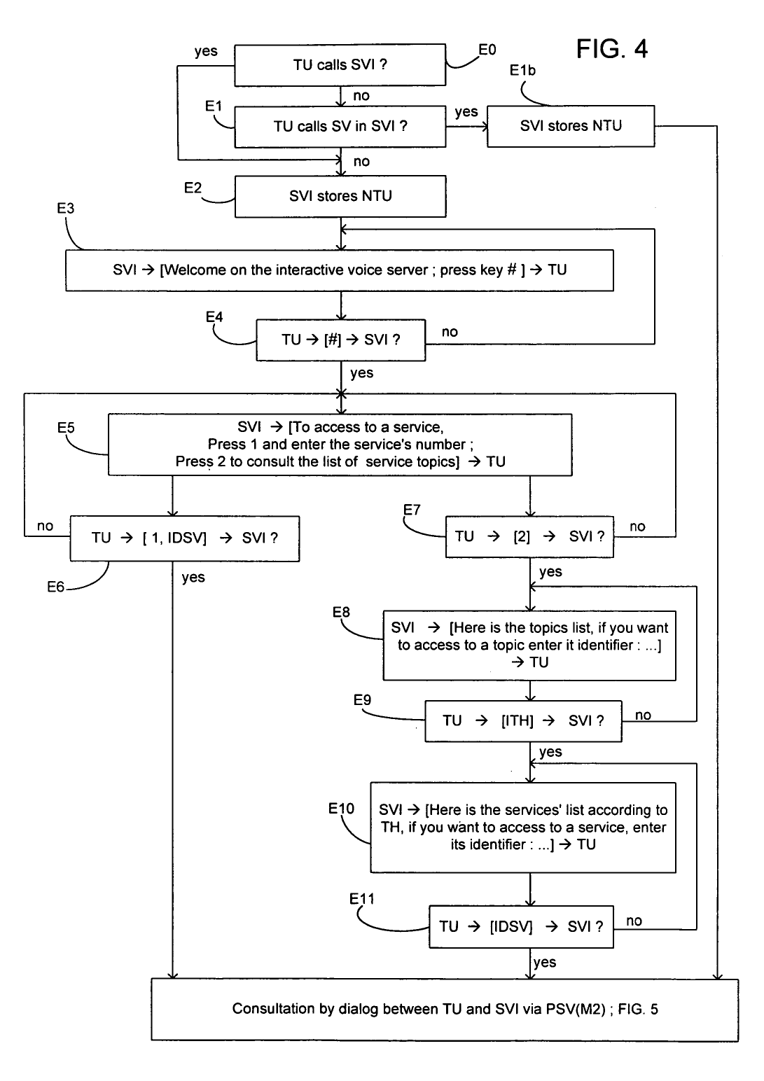

FIG. 4 depicts an algorithm of the invention for voice service selection from a user terminal; and

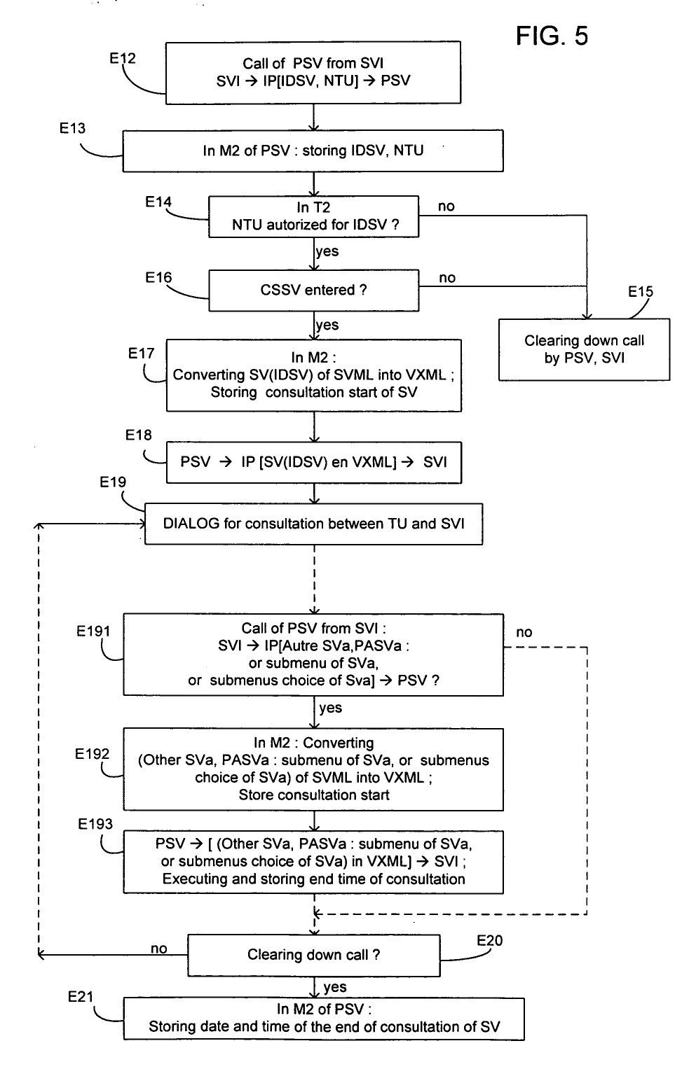

FIG. 5 shows an algorithm of the invention for consulting a selected voice service.

Referring to FIG. 1, an interactive telephone voice services system comprises, firstly, means for publishing a voice service by any user, hereinafter called as an administrator A, and, secondly, means enabling consultation of the voice service in particular by users of the telephone network.

The publishing means essentially comprises at least one administrator terminal TA, which is typically a personal computer connected to a packet-switched network RP, such as the Internet, and a voice services management platform PSV, which is also connected to the Internet RP and is associated with a database BD. The administrator A is a non-expert user, for example, or the representative of a community such as a sports club, an association or a group of professionals.

The voice service consultation means essentially comprises the platform PSV offering a network of voice services in accordance with the invention, an interactive voice service SVI containing in particular a voice synthesizer module and able to communicate with the platform PSV via the Internet RP, and a plurality of user telephone terminals TU connected to the voice service SVI via an access network RA. Voice services are called up from the user terminals TU in the voice server SVI to be executed therein in a first prior art execution language, for example VXML. The access network RA may be the PSTN public switched telephone network and/or an ISDN integrated services digital network and/or the fixed network of a cellular mobile radio network if the user terminal TU is a mobile radio telephone.

Where the invention is concerned, the voice services platform PSV essentially comprises two software modules M1 and M2 and the database BD. Alternatively, the modules M1 and M2 are installed on two separate platforms connected via the network RP.

The first module M1 is used for simplified publishing any interactive voice service in the form of a file in a second programming language SVML (Simple Voice Markup Language) by the administrator A sitting at the terminal TA.

SVML language is a high-level programming language specific to the invention that provides a simple way to define an interactive voice service having a tree structure.

For example, FIGS. 2A and 2B show a screen page PE displayed on the administrator terminal TA in accordance with instructions and data delivered by a publishing application module M1A derived from the module M1 and downloaded from the platform PSV. The left-hand portion (FIG. 2A) of the screen page shows the tree structure AR of an interactive voice service “10 10” that has been created by filling in fields of forms FO displayed successively in the right-hand portion (FIG. 2B) of the screen page.

In the left-hand portion of the screen page, the “loudspeaker” icon designates broadcast voice information (Label), such as comments, headings or instructions, the icon in the form of an open file designates access to the content of a menu or a submenu, and the icon in the form of a square key designates the voice prompt to a branch in a choice, such as pressing a keypad key 1 to 4 of a user terminal or telephone TU, or returning to a calling menu or terminating (exiting) the interactive voice service created.

In the right-hand portion of the screen page PE (FIG. 2B), a form may contain a “DTMF” (Dual Tone MultiFrequency) button for selecting the number of a key of the keypad of the telephone terminal TU in corresponding relationship to information such as “Give cat”, as shown on the form FO in FIG. 2B, or to instructions (Label) that are entered or have been entered on the keypad of the administrator terminal TA and stored in a text file such as “advert5.txt” to be downloaded into the module M1 and to be stored and voice synthesized in the voice synthesizer module of the server SVI, or to instructions that are or have been spoken directly by the administrator into the microphone of the terminal TA and stored in an audio file such as “advert3.wav” to be downloaded into the module M1 and to be read subsequently in the server SVI.

The administrator may also choose a sound file such as “advert2.wav” or a text file such as “advert4.txt” designated by its URL (Uniform Resource Locator) and included in a terminal or other platform, such as a voice and/or text document platform PFD connected to the Internet RP, as shown in FIG. 1. A form FO may also contain, associated with any of the above information, fields for specifying validity start (from) and end (until) dates, or one or more validity dates during which the information is available, in this instance the information “Give cat”.

In this way, thanks to scrolling through the forms FO on the terminal TA, under the control of the administrator, the latter selects elements of the voice service to be created, such as menus, choices in a menu, broadcasting of information, etc. The elements available correspond to tags of the SVML language according to the invention and are defined in appendices 1 and 2 of the present description. The script of the interactive voice service corresponding to the tree structure AR shown in FIG. 2A and written in SVML language is defined in appendix 3 of the present description.

The syntax of SVML language is substantially similar to existing markup languages (ML) such as HTML (HyperText Markup Language). Among the various tags defined with their attributes in appendix 1 in a manner somewhat similar to tags in prior art high-level languages, the following characteristics specific to the invention will be noted:
the attribute export=“true/false” may be an attribute of the “svml” tag bracketing a voice service of the invention in order to restrict access thereto, i.e. in order to authorize (true) or prohibit (false) a call to this first service from a call to another voice service using an identifier of the first service; the export attribute may also be that of a choice tag or a menu tag in order for a portion of that service corresponding to a choice or a menu to be accessible or not from another voice service of the invention using an identifier of said portion, as a function of the voice service access policy; execution in cascade of portions of voice services may be authorized thanks to attributes export=“true” in portions of a plurality of services each containing the identifier of the next portion;
the attributes begin=“start of validity date”, end=“end of validity date” and validdate=“validity date” respectively designate, in relation to an item of data, dates between which the item of data is broadcast from the platform PSV and a validity date of the data item that may not be used with either of its previous two attributes; these attributes are introduced into the choice, data, default, goodbye and welcome tags in the platform PSV by the terminal TA during subsequent publishing steps C51 or C6 (FIG. 3); for example, the first two attributes indicate the start and the end of a product promotion period or a period for subscribing to an activity and the third attribute indicates the date of closure of a store or the absence of a particular service;
the attribute txt=“text file reference” that may be included in the action, data, default, goodbye, description (label), parameter and welcome tags is used in the administrator terminal TA to enter a reference of a text file in order for the text in the file to be synthesized automatically in the server SVI afterwards, and thereby constitute an item of information or an instruction that will be broadcast to a user terminal TU;
the attribute passwd=“string of digits” that may be included in the menu or svml tag designates a secret code CSSV or CSPASV entered by the administrator A to protect access to the service created, whose file is between two svml tags, or to a portion of this service between two menu tags;
by broadcasting data such as the absence of a product or an activity, the default tag <default> is used to signal that it has not been possible to broadcast any of the choice data because of validity dates, for example during unavailability of a product or absence of an activity;
the call tag <gosub> either creates a link to a voice service menu or a submenu in order to execute the submenu, such as “external_contents”, in a menu of the service that is itself designated by the attribute src=“#menu_id”, in which menu_id designates a submenu identifier IDM in the file of the published service SV; or the tag <gosub> creates a link with another personalized interactive voice service (SVIP) that is to be called and is implemented either on the platform PSV or on another platform according to the invention and designated by an identifier “num”, such as “10 11”, according to the attribute src=“svip://svip_num”, or with a portion of the other voice service designated by an identifier “menu_id”, such as “input menu”, in accordance either with the attribute src=“svip://svip_num≠menu_id” or with a choice in a menu of the other voice service that is designated by an identifier “choice_nb”, such as “3”, to choose option 3 in the “input” menu in the “10 11” service in accordance with the attribute src=“svip://svip_num≈menu_id:choice_nb”; if the other called voice service “num”, hereinafter designated SVa, is implemented on another platform PSVa (FIG. 1) for managing voice services in accordance with the invention, the called voice service identifier is associated with the URL of the platform PSVa and the identifier of the path on the platform PSVa to reach the called voice service; the call tag <gosub> thus constitutes a call in the published voice service SV for calling and launching another voice service SVa, or at least a portion thereof, in order for that other voice service or the portion thereof to be executed during execution of the published voice service that is called from a user terminal TU via the interactive voice server SVI or from another voice service, and so on;
the return tag <return> is obligatory for exiting a called voice service or a called choice or menu, i.e. a called service portion, in order to return to the calling service that called the called service or service portion at the point at which it was interrupted.

Compared to prior art audio services designated by a telephone number, such as “the weather”, the return tag according to the invention is used to return in the “opposite” direction to the call tag <gosub> to successive interactive voice services called up in cascade. The call tag entered in a calling service to call a called service by means of its identifier and the return tag entered in the called service to return to the calling service constitute a real link between the voice services, enabling navigation within the services. Thanks to such links, the invention constitutes a network of interactive voice services within which a user may navigate from his user terminal TU.

The first module M1 of the voice services platform PSV guarantees that the published interactive voice service conforms to the general organization of services in accordance with the invention enabling sharing of data and navigation between the services. Created elements of the service may be inserted only at certain positions in the tree structure of the service, in accordance with the constraints defined in appendices 1 and 2. The SVML code, which is an instance of the eXtensible Markup Language (XML), is either generated automatically by a publishing application module M1A downloaded into the terminal TU or written directly by the administrator on the terminal TA before being saved in the module M1 of the platform. Each node of the tree structure is described in a static or dynamic form by means of an identifier, which may refer either to SVML codes for a non-terminal node of the structure, or to the textual content that will be synthesized in the form of speech subsequently and automatically in an interactive voice server SVI, or to an audio file in the case of a leaf of the tree structure.

Thus a voice service created in accordance with the invention corresponds to a root file in SVML language.

Referring now to FIG. 3, publishing an interactive voice service according to the invention by an administrator at the terminal TA essentially comprises steps C1 to C14.

In step C1, the terminal TA calls the voice services platform PSV by transmitting an IP packet with the source address ATA of the terminal TA and the destination address APSV of the platform PSV via the Internet network RP. After this connection is set up between the terminal TA and the platform PSV, the module M1 imposes or prompts the entry of an identifier IDSV of an interactive voice service SV to be published and imposes the specification of an administrator password MPA in step C2. The password from the administrator A is transferred from the terminal TA to the module M1 where it is stored in corresponding relationship with the voice service identifier IDSV in step C3. The stored password must be entered subsequently after entering the voice service identifier IDSV at the terminal TA each time that the administrator wishes to access the interactive voice service SV that is being published, in particular to modify it. The database BD associated with the platform PSV contains a first table of correspondences T1 (FIG. 1) establishing the correspondences between identifiers IDSV of interactive voice services that have been published or are being published and administrator passwords MPA.

Then, in step C4, the module M1 downloads the publishing application module M1A into the terminal TA to proceed with actually publishing an interactive voice service SV, in order for the administrator A to establish a tree-structured browsing scheme by dialog with the downloaded module M1A and without intervention by the platform PSV. For example, the module M1 is implemented in the platform PSV in JavaScript in order for the module M1A to be used by means of a known web browser implemented in the administrator terminal TA. The graphical description of the service by means of filled in forms FO is automatically translated into the SVML language according to the invention in the module M1A. The module M1A may offer the administrator voice service publishing, guiding him through selected one of prestored voice service browsing tree patterns, as indicated in steps C5 and C51, in particular by means of screen pages like that shown in FIGS. 2A and 2B, the right-hand page portion of which is filled in for each form FO and the left-hand page portion of which displays the progressive formation of the tree structure AR of the service being published. Alternatively, the module M1A prompts the administrator to program the voice service SV to be published in SVML himself, as indicated in step C6.

During construction of the browsing tree structure AR of the SVML language interactive voice service SV in the module M1A, the administrator may be called upon to execute one of the following steps for the SVML language voice service SV, in the module M1A and via the graphical interface of the terminal TA:
C7: introducing into the voice service SV in the module M1 the identifier of a text file or of a sound file that is either entered directly at the terminal TA by the administrator or read if it is prestored in the terminal TA, in corresponding relationship to the attribute txt or snd, in order to download it with the service SV into the platform PSV when the service is saved, and subsequently to store it, and where appropriate to synthesize a voice file from it, if the original file is a text file in the interactive voice server SVI during execution of the service;
C8: introducing into the voice service SV in the module M1A either the URL address of a text file to be stored and subsequently synthesized into the form of a voice file in the server SVI during execution of the service, or the URL address of a sound file, in order for that file to be played back subsequently when executing the created service SV, which corresponds to the attribute txt or snd, the text or sound file being available on another, remote document platform PFD (FIG. 1) connected to the network RT, for example;
C9: introducing into the voice service SV in the module M1A at least the identifier IDSVa of another voice service SVa according to the invention, a service portion identifier IDPASVa, such as the identifier IDSM of a submenu of another voice service SVa, or the identifier IDCH of a choice of submenus of another voice service SVa, in order to create a link between the services SV and SVa by means of the call tag <gosub>, and more generally to introduce a plurality of identifiers of other services into the service SV in order to network a plurality of services; the module M1A facilitates the search for import identifiers by classifying the voice services to be imported by topics, such as sports, weather, stock exchange, news, etc., and by publishers, thanks to a classification of the services created, as see below in step C11;
C10: to the contrary, instead of importing another voice service or a portion thereof into the service SV, restricting calling up of the voice service SV or of at least a portion PASV of the voice service SV, after it has been published, by other services SVa able to call up the service SV or a portion thereof; this restriction is signaled in the service SV by the state of the export attribute in the svml service tags in, or menu or choice tags for authorizing (true) or prohibiting (false) calling up the service SV or a portion PASV thereof, such as a menu or a choice of submenus;
C11: supplying a predetermined secret code CSSV or CSPASV in order to associate it with the service SV being published, in corresponding relationship to the identifier IDSV, in the module M1A, or to associate it with a portion PASV of the service SV in corresponding relationship to the identifier IDPASV in the module M1A; these correspondences are downloaded into a second table T2 of the database BD of the platform PSV when saving the service SV, as shown in FIG. 1; the second table T2 may also cause to correspond to each identifier/secret access code pair (IDSV, CSSV), (IDPASV, CSPASV) of the voice services and voice service portions PASV created a respective list of telephone numbers NTU of user terminals TU that are authorized to access the service SV or the service portion PASV, which list is kept updated by the administrator A of the service SV; only users designated in the list may then consult the voice service or a portion thereof; subsequently, the administrator A of the service SV updates the list by adding or removing user telephone numbers to authorize or prohibit access to the service or to a portion thereof to users designated by their telephone terminal call numbers NTU, in particular to enable the administrator of the service to invoice access to the service SV by means of a subscription; access to the corresponding voice service or voice service portion is therefore limited by a secret code CSSV, CSPASV and/or by a number NTU in the corresponding list.

The parameters and in particular the lists in the table T2 are subsequently managed in the platform PSV by the second module M2.

Finally, when the administrator A has described the tree structure AR of the service created, for example as shown in FIG. 2A, the module M1A prompts him to summarize it by providing either a voice summary or a text summary to be voice synthesized afterwards by the server SVI that will be transmitted to all users calling the voice service that has been created. The module M1A classifies the SVML language voice service that has been published into at least one topic class and one publisher class in the step C12.

When the voice service SV has been entirely defined, as indicated in step C13, the administrator A validates publication of the SVML service SV in step C14 in order for the service SV to be saved and checked in the database BD under the control of the module M2.

The second module M2 in the platform PSV is written in C++, for example, and serves as a “compiler” from SVML language into VXML language. Subsequently, this compiler automatically translates the description of the interactive voice service SV previously published in SVML language into VXML language, compatible with the voice server SVI, to transmit the VXML language service SV to the server SVI when the service SV in the database BD is called up from a user terminal TU. In step C14, the module M2 checks if the SVML code produced for the created service SV, according to appendix 3 for example, conforms to the rules set out in appendix 1; where appropriate, the module M2 signals via the network RP certain errors in the SVML code of the published voice service SV to the administrator terminal TA in order for them to be corrected, in particular if the administrator wrote the service in SVML language in step C6.

The module M2 is also used to respond to requests for consultation of the published voice services SV from the user terminal TU and to store a log of consultations for each service SV that may be read by a telephone operator offering the services. In particular, the module M2 that manages the telephone numbers NTU of the user terminals TU is capable of assisting with invoicing access to each service by means of a subscription, for example, or any other charging formula associated with the voice service that may be offered during publication of the service by the module M1A or subsequently by the module M2. The module M2 typically associates, in a table T3 of the database BD, a number NTU of a user terminal TU, consulted voice service identifiers IDSV or consulted voice service portion identifiers IDPASV, and the times of consultation start and end of voice services by the user terminal, in order to deduce therefrom the durations of consultation of each service, distribute the consultation revenue between the voice service providers, and establish statistics. Charging may consist in a transfer dependent on the number or the duration of calls.

After the step C14, the published voice service SV is deemed to be available to the public, i.e. available to any authorized user from a telephone terminal TU.

Subsequently, as indicated in step C15 in FIG. 3, the administrator may, if he wishes, update the SVML voice service SV by connecting the terminal TA to the platform PSV. After validation of the identifier IDSV of the service in corresponding relationship with the password MPA in the table T1, as in steps C2 and C3, the module M1 transfers the published voice service SV in order for it to be displayed in the terminal TA on a screen page analogous to that shown in FIG. 2. The administrator selects graphical elements of the service SV (FIG. 2A) and modifies the contents corresponding to the selected elements by means of forms (FIG. 2B); he may also add or remove one or more branches of the tree structure AR of the service by means of a toolbar and under the control of the downloaded module M1A. For each branch or leaf, the module M1A offers a choice for storing a new instruction or item of information. The modification steps are analogous to the service publishing steps C5 to C12, based on diverse parameters and data already specified when publishing the service. The voice service modified in this way is saved in place of the preceding one in the database BD of the platform PSV.

Alternatively, the administrator of the created service SV modifies certain leaves of the service from a telephone terminal. To this end, the administrator calls a telephone number reserved for modifications and corresponding to a voice server analogous to the interactive voice server SVI for users and communicating with the platform PSV via the Internet network RP. To access the service SV, the administrator enters the service identifier IDSV and a multidigit secret code specified when creating the service and corresponding to his administrator account. The administrator then browses the service SV in the same way as a telephone terminal user. When the administrator accesses a branch or a leaf of the service tree, the module M1 of the platform PSV offers him a new choice and the administrator speaks a new message, which is recorded in the database BD via the module M1, in place of the old message. After the new version of the service is saved in the module M1 of the platform PSV, it is accessible via any user terminal TU.

When the service SV is updated, a user who is in the process of consulting the service cannot access the modified service until either the user or the service being consulted by the user has called up the modified service after the latter has been saved in the module M2. For example, if the called service SV is linked to a portion PASVa of another service, the user cannot access the modified service portion PASVa if the latter is being updated when the service SVa is called up by the service SV during execution of the latter and until the instruction to return to the service SV has been executed in the service SVa; if the portion PASVa is called up again by the service SV after the new version of the portion PASVa has been saved, then the service SV will access the new version of the portion PASVa that has been modified.

To select and consult a voice service SV stored in the interactive voice service database BD of the platform PSV, a call is set up between a user telephone terminal TU and the interactive voice server SVI via the access network RA in the manner shown in FIG. 4 and a call is set up between the server SVI and the voice services platform PSV in the manner shown in FIG. 5.

The server SVI is a platform which interprets VXML language in each interactive voice service SV that is selected by a user and supplied dynamically by the module M2 of the platform PSV, after conversion from SVML language to VXML language in the module M2, in order to make it available to the calling user.

As shown in FIG. 4, the selection of an interactive voice service SV from a user terminal TU essentially comprises steps E0 to Eli.

In the conventional way, the terminal TU calls the interactive voice server SVI via the access network RA, for example the public switched telephone network, after the user has entered on the keypad of the terminal TU the telephone number of the server SVI in step E0. The server SVI then stores the telephone number NTU of the terminal TU in order, where appropriate, to have the module M2 check in the database BD, in a subsequent step E14, that the number NTU is in a list of authorized numbers in the table T2, in corresponding relationship with a service SV or a service portion PASV.

Alternatively, as indicated in steps E1 and E1b, the user enters at the terminal TU a telephone number NSV to call directly the voice service SV of his choice in the server SVI, which stores the number NTU and makes the service number NSV correspond to the identifier IDSV in order to call immediately the server SVI of the platform PSV, as will be explained in connection with step E12 in FIG. 5.

In the steps E3 and E4 that follow on from the call to the server SVI, the server SVI transmits a welcome voice message to the terminal TU and prompts the user to access a voice service by pressing a predetermined key, such as the hash key.

In response to pressing the hash key, in step E5 the server SVI prompts either entry of a number or an identifier IDSV associated with a service SV that the user may happen to know already by pressing a first key, such as the “1” key, or consultation of all services classified by topic by pressing a second predetermined key, such as the “2” key.

If, in the next step E6, the terminal TU transmits the server SVI in DTMF code the number “1” of the first key pressed followed by the identifier IDSV of a service, the selection process goes directly to step E12 in FIG. 5.

On the other hand, if the user has pressed the second predetermined key “2” of the terminal TU, as indicated in step E7, the server SVI transmits a voice message listing topics and their identifiers and prompting the user to enter the topic identifier ITH corresponding to his choice in step E8. In response to a topic identifier ITH transmitted by the user terminal TU to the server SVI in step E9, in step E10 the server SVI prompts the user to select a service from a list of services with their identifiers conforming to the chosen topic TH, by entering the identifier IDSV of the chosen service SV. Then, in response to the identifier IDSV of the service SV selected in step E11, the chosen voice service SV is consulted by means of a dialog between the terminal TU and the voice server SVI, via the platform PSV, as shown in FIG. 5.

In response to the identifier IDSV of the voice service SV chosen by the user and transmitted to the server SVI in step E6 or Eli, the server SVI stores the identifier IDSV of the chosen service SV in association with the telephone number NTU of the user terminal TU and transmits them in an IP call packet to the platform PSV in step E12. The module M2 of the platform PSV stores the IDSV-NTU pair in step E13. The module M2 checks before step E14 whether the user designated by the number NTU is authorized to consult the selected service designated by the identifier IDSV in the table T2. If the number NTU is not found in corresponding relationship with the identifier IDSV in the table T2, the user is not authorized to consult the selected service and the platform PSV clears down the call with the server SVI which clears down the call with the user terminal TU in step E15. Otherwise, the user may be prompted in step E16 to enter the confidential access code CSSV, which the module M2 receives via the server SVI in order to compare it to that listed in corresponding relationship with the identifier IDSV in the table T2. If the code CSSV entered is incorrect, the call is cleared down in step E15.

Otherwise, if the user is authorized to consult the selected voice service SV designated by the identifier IDSV in step E14 and, where applicable, has entered the confidential code CSSV correctly in step E16, the program of the selected service SV designated by the identifier IDSV and written in SVML language in the database BD is converted by the module M2 into VXML language compatible with the voice server SVI, in step E17. The date and time at which the current consultation began are stored during this step. Using IP packets, the platform PSV transmits the program of the selected VXML language service SV to the server SVI in step E18 in order to instigate a dialog between the terminal TU and the server SVI conforming to browsing within the chosen voice service SV in step E19. For example, the consultation of the service described in appendix 3 is effected in accordance with the tree structure AR shown in FIG. 2A.

As shown by steps E191, E192 and E193 in FIG. 5, during execution of the selected voice service SV in the interactive voice server SVI based on VXML language and therefore on the user browsing within the selected service SV, the server SVI may be called upon to call up the platform PSV or another platform in accordance with the invention in order to consult another voice service SVa or a portion PASVa of that other voice service SVa, such as a submenu or a choice of submenus, if the identifier IDSVa, IDPASVa is linked to a call tag <gosub> included in the program of the selected service SV and there is no export attribute in the “false” state prohibiting access to the called service SVa or to the called service portion PASVa. The module M2 of the called platform PSV dynamically converts the other service SVa or the service portion PASVa, such as a submenu or choice of submenus of the service Sva, originally written in SVML language, and stores the date and the time at which consultation of the service SVa or the service portion PASVa began. The platform PSV transmits the service SVa or the service portion PASVa that has been called up to the interactive server SVI by means of IP packets. The server SVI executes the other service SVa or service portion PASVa that has been transmitted for consultation of said other service SVa or said portion, that is to say for consultation of the submenu of the service SVa or for selecting a choice of menus or submenus in the other service SVa, and then returns to executing the selected service SV. The end time of consultation of the service SVa or service portion PASVa is also stored in the module M2.

In an analogous manner to steps E191 to E193, the server SVI may be called up via the platform PSV to call a text file to be synthesized in the voice synthesizer module of the server or a prerecorded sound file designated by its URL address.

Finally, when the call between the terminal TU and the server SVI is cleared down, which is relayed by clearing down the call between the server SVI and the platform PSV in step E20, the module M2 of the platform PSV stores the date and time of the end of consultation in order to deduce the duration of the consultation therefrom, in step E21, as a function of the date and time at which consultation began, and where applicable to invoice the user and to divide the consultation revenue between the administrators of the consulted services and service portions.

### Appendix 1: Syntax of the Simple Voice Markup Language (SVML)

Attributes or tags that are underlined are obligatory.

The date format is “dd/mm/yyyy hh:mm:ss” (day/month/year hour:minute:second). From 1 to n values may be defined (for example “dd/mm”); in this case the missing values are replaced by the current values. To force a value of dd/mm/yyyy to the current value, 0 may also be used: for example “0/12/0 10:20” denotes the month of December of the current year at 10h20.

<action>

<action> . . . </action>
<action . . . />
   Attributes:
snd=“http://url_sound”
   URL of the action with an audio result of sound file type.
txt=“http://url_text”
   URL of the action with an audio result of text-to-be-synthesized type.
url=“http://url”
   URL of an action with no audio result.
N.B. only one of the parameters snd, txt or url is obligatory.
desc=“description”
   Free description of the action.
      Englobing tags:
<choice>
   Sub-tags:
<goodbye> <param> <welcome>
   Contents:
None.
   Use:
Triggering of an action via a URL. The returned document, if it is used, may be a sound file or a text to be synthesized after the action. Actions can be useful for consulting external databases, triggering processes of any kind, etc. Parameters may be introduced into the URL of the action by using a <param> tag.
   <choice>
<choice> . . . </choice>
   Attributes:
dtmf=“telephone keypad key”
   Key by which the choice is accessed.
begin=“start of validity date”
   Date from which the choice is offered.
end=“end of validity date”
   Date after which the choice will no longer be offered.
export=“true/false”
   Determines if the choice is usable by another interactive voice service SVIP. Supplants the “export” directive of the <svml> tag.
validdate=“validity date”
   Start and end of validity date. Do not use with begin and end. For example “0/9/0” designates a validity throughout the month of September, regardless of the day and the year.
      Englobing tags:
<menu>
   Sub-tags:
<action> <data> <default> <exit> <label> (obligatory if no <data> in englobing <menu>) <gosub> <transfer>
   Contents:
None.
   Use:
Definition of a possible choice in a menu. It is possible to specify a validity interval (begin, end and validdate attributes) outside of which the choice is not offered.
   <data>
<data> . . . </data>
<data . . . />
   Attributes:
snd=“audio file reference”
   Data in the form of an audio file.
txt=“text file reference”
   Data in the form of a text file.
begin=“start of validity date”
   Date from which the data is broadcast.
end=“end of validity date”
   Date after which the data will no longer be broadcast.
validdate=“validity date”
   Start and end of validity date. Do not use with begin and end.
N.B. a parameter snd or txt is obligatory if no text content is defined.
   Englobing tags:
<choice> <menu> <return>
   Sub-tags:
None.
   Contents:
Data in text form.
   Use:
Broadcasting of data. It is possible to specify a validity interval (begin, end and validdate attributes) outside which the data is not broadcast.
In a choice of menu (<choice> or <return> tags) the data is broadcast if this choice is selected. In a menu (<menu> tag), the data constitutes the statement of the choices of the menu (for example to group this statement into a single audio file). In this latter case, the statement of the <label> tags of the choices are ignored.
   <default>
<default> . . . </default>
<default . . . />
   Attributes:
snd=“audio file reference”
   Data in the form of an audio file.
txt=“text file reference”
   Data in the form of a text file.
begin=“start of validity date”
   Date from which the data is broadcast.
end=“end of validity date”
   Date after which the data will no longer be broadcast.
validdate=“validity date”
   Start and end of validity date. Do not use with begin and end.
N.B. an snd or txt parameter is obligatory if no text content is defined.
   Englobing tags:
<choice> <return>
   Sub-tags:
None.
   Contents:
Data in text form.
   Use:
Broadcasting of data if it has not been possible to broadcast any of the data of the choice because of the validity dates. In this case, at least one <default> tag is needed with a validdate (or with no date), any choice having to contain at least a content or an action.
   <exit>
<exit/>
   Englobing tags:
<choice>
   Attributes, sub-tags, contents:
None.
   Use:
Final exit from the service.
   <goodbye>
<goodbye> . . . </goodbye>
<goodbye . . . />
   Attributes:
snd=“audio file reference”
   Data in the form of an audio file.
txt=“text file reference”
   Data in the form of a text file.
begin=“start of validity date”
   Date from which the data is broadcast.
end=“end of validity date”
   Data after which the data will no longer be broadcast.
validdate=“validity date”
   Start and end of validity date. Do not use with begin and end.
N.B. an snd or txt parameter is obligatory if no text content is defined.
   Englobing tags:
<action> <menu> <svml>
   Sub-tags:
None.
   Contents:
Data in text form.
   Use:
Identical to <data>, except that the data broadcast is broadcast only on exiting a menu or the main application or after an action.
   <gosub>
<gosub . . . />
   Attributes:
src=“#menu_id”
src=“svip://svip_num”
src=“svip://svip_num#menu_id”
src=“svip://svip_num#menu_id:choice_nb”
   Englobing tags:
<choice> <menu> <svml>
   Sub-tags, contents:
None.
   Use:
change of menu in the service. It is possible to specify:
   either a menu identifier in the current file,
   or a URL or a file name where applicable followed by a menu identifier (if no identifier, the first menu is used).
      <label>
<label> . . . </label>
<label . . . />
   Attributes:
snd=“audio file reference”
   Description of the choice by an audio file.
txt=“text file reference”
   Description of the choice by a text file.
N.B. an snd or txt parameter is obligatory if no text content is defined.
   Englobing tags:
<choice> (obligatory if no <data> in <menu> englobing the <choice>)<return>
   Sub-tags:
None.
   Contents:
Description of the choice in text form.
   Use:
To describe a menu choice.
   <menu>
<menu> . . . </menu>
   Attributes:
export=“true/false”
   Determines if the menu is usable by another interactive voice service SVIP.
   Supplants the “export” directive of the <svml> tag.
id=“menu_id”
   Menu identifier (which must be unique).
passwd=password: “string of digits”
   User access code.
      Englobing tags:
<svml>
   Sub-tags:
<choice> <data> <goodbye> <return> <welcome>
   Contents:
None.
   Use:
Definition of a multiple choice menu.
   <param>
<param> . . . </param>
<param . . . />
   Attributes:
name=“parameter name”
   Name of the parameter that will be transmitted in the URL address of the action.
snd=“audio file reference”
   Data in audio file form.
txt=“text file reference”
   Data in text file form.
type=“parameter type”
   The possible type values are:
      Boolean: the user may type 1 for yes, true, etc. or 2 for no, false, etc. The parameter transmitted to the URL of the action will be the string “true” (for 1) or “false” (for 2).
      date: date in the format YYYYMMDD.
      digits: any one or more digits.
      currency: monetary value. In the parameter transmitted to the URL, the star will be replaced by the decimal point ‘.’.
      number: number. In the parameter transmitted to the URL, the star will be replaced by the decimal point ‘.’.
      phone: telephone number. In the parameter transmitted to the URL, the star will be replaced by the character ‘x’.
      time: time in the format HHMM. The string parameter transmitted to the URL will be followed by the character ‘?’ for times entered from 0000 to 1259 and ‘h’ for times entered from 1300 to 2459. Inputs 2400 to 2459 will be replaced by “0000h” to “0059h”.
N.B. an snd or txt parameter is obligatory if no text content is defined.
   Englobing tags:
<action>
   Sub-tags:
None.
   Contents:
Data in text form.
   Use:
Definition of a parameter that will be transmitted in the URL of an action, and of the data broadcast to request the user to enter information. The information entered is a number terminating in #.
   <return>
<return> . . . <return/>
   Attributes:
dtmf=“telephone keypad key”
   Key by which the choice is accessed.
      Englobing tags:
<menu>
   Sub-tags:
<data> <default> <label> (obligatory if no <data> in englobing <menu>)
   Contents:
None.
   Use:
Definition of a menu choice to exit the menu to return to the calling menu (default behavior), to terminate the service definitively (sub-tag <exit>) or to reroute the call definitively to a number (sub-tag <transfer>).
   <svml>
<svml> . . . </svml>
   Attributes:
desc=“description”
   Free description of the SVIP.
export=“true/false”
   Determines if the voice service SVIP is usable by another interactive voice service. Defines a default policy that may be redefined at the level of the <menu> and <choice> tags.
passwd=password: “string of digits”
   User access code.
      Englobing tags:
None.
   Sub-tags, contents:
<goodbye> <menu> <gosub> <welcome>
   Use:
Tag englobing all tags of a service descriptive file.
   <Trans fer>
<transfer . . . />
   Attributes:
dest=destination: “phone://telephone number”
   Englobing tags:
<choice>
   Sub-tags, contents:
None.
   Use:
Rerouting to a telephone number.
   <Welcome>
<welcome> . . . </welcome>
<welcome . . . />
   Attributes:
snd=“audio file reference”
   Data in audio file form.
txt=“text file reference”
   Data in text file form.
begin=“start of validity date”
   Data from which the data is broadcast.
end=“end of validity date”
   Date after which the data will no longer be broadcast.
validdate=“validity date”
   Start and end of validity date. Do not use with begin and end.
      Englobing tags:
<action> <menu> <svml>
   Sub-tags:
None.
   Contents:
Data in text form.
   Use:

Identical to <data>, except that the data is broadcast only on entry into a menu or into the main application, or before execution of an action.

APPENDIX 2
Summary of SVML tags

| | | | | Must be | May be | | |
|---|---|---|---|---|---|---|---|
| <tag> | | Obligatory | Optional | contained | contained | Must | |
| (name) | Use | attributes | attributes | in | in | contain | May contain |
| <action> | Triggers an | snd or txt | desc | <choice> | — | — | <goodbye> |
| | action via a | or url | | | | | <param> |
| | URL | | | | | | <welcome> |
| <choice> | Defines a | dtmf | begin | <menu> | — | <label> | <action> |
| | possible | (key) | end | | | (if no | <data> |
| | choice in a | | export | | | <data> in | <default> |
| | menu | | validdate | | | <menu>) | <exit> |
| | | | | | | | <gosub> |
| | | | | | | | <transfer> |
| <data> | Broadcasts | If no text | snd | — | <choice> | If no snd | Text data |
| | data, menu | data | txt | | <menu> | or txt | |
| | prompt | defined: | begin | | <return> | attribute: | |
| | | snd or txt | end | | | text data | |
| | | | validdate | | | | |
| <default> | Broadcasts | If no text | snd | — | <choice> | If no snd | Text data |
| | data if no | data | txt | | <return> | or txt | |
| | validdate | defined: | begin | | | attribute: | |
| | | snd or txt | end | | | text data | |
| | | | validdate | | | | |
| <exit> | Exits service | — | — | — | <choice> | — | — |
| | definitively | | | | | | |
| <goodbye> | Data | If no text | snd | — | <action> | If no snd | Text data |
| | broadcast at | data | txt | | <menu> | or txt | |
| | end of menu | defined: | begin | | <svml> | attribute: | |
| | or action | snd or txt | end | | | text data | |
| | | | validdate | | | | |
| <gosub> | Calls a | src | — | <svml> | <choice> | — | — |
| (submenu) | submenu | | | | <menu> | | |
| <label> | Describes a | If no text | snd | <choice> | — | If no snd | Text data |
| (description) | menu choice | data | txt | (if no | | or txt | |
| | | defined: | | <data> in | | attribute: | |
| | | snd or txt | | <menu>) | | text data | |
| | | | | <return> | | | |
| <menu> | Defines a | id | export | <svml> | — | <choice> | <data> |
| | multiple | (Identifier) | passwd | | | <return> | <goodbye> |
| | choice menu | | | | | | <welcome> |
| <param> | Defines a | name | — | <action> | — | — | Text data |
| (parameter) | parameter | If no text | | | | | |
| | transmitted | data | | | | | |
| | to an action | defined: | | | | | |
| | | snd or txt | | | | | |
| | | type | | | | | |
| <return> | Defines a | dtmf | — | <menu> | — | <label> | <data> |
| | choice for | (key) | | | | (if no | <default> |
| | exiting a | | | | | <data> in | |
| | menu | | | | | <menu>) | |
| <svml> | Tag englobing | export | desc passwd | — | — | <menu> | <goodbye> |
| (SVML file) | all tags of | | | | | <gosub> | <welcome> |
| | an SVML file | | | | | | |
| <transfer> | Reroutes to a | Dest | — | — | <choice> | — | — |
| | telephone | (destination) | | | | | |
| | number | | | | | | |
| <welcome> | Data | If no text | snd | — | <action> | If no snd | Text data |
| | broadcast at | data | txt | | <menu> | or txt | |
| | start of menu | defined: | begin | | <svml> | attribute: | |
| | or action | snd or txt | end | | | text data | |
| | | | validdate | | | | |

APPENDIX 3
SVML code for the AR service from FIG. 2A

```
<svml export=“true” desc=“complete example”>
  <welcome>Welcome to 10 10.</welcome>
  <goodbye>You are exiting 10 10, goodbye.</goodbye>
  <gosub src=“#main_menu”/>
  <menu id=“internal_contents” passwd=“1234”>
    <choice dtmf=“1” export=“false”>
      <label>Press 1 for adverts</label>
      <data end=“15/12/2001”>Give cat.</data>
      <data snd=“http://www.adverts.fr/advert2.wav”
end=“31/12/2001”/>
      <data snd=“file:C:\ advert3.wav”/>
      <data txt=“http://www. adverts.fr/advert4.txt”
end=“31/12/2001”/>
      <data txt=“file:C:\ advert5.txt” begin=“01/01/2002”
end=“01/06/2002”/>
      <default>No adverts at the moment.</default>
    </choice>
    <choice dtmf=“2” validdate=“*/12/*”>
      <label>Press 2 for Christmas promotions</label>
    </choice>
    <return dtmf=“*”>
      <label>Press star to exit</label>
    </return>
  </menu>
  <menu id=“external_contents”
    <choice dtmf=“1”>
      <label>Press 1 for times of tides</label>
      <action txt=“http://www.calcultide.fr/calcul.cgi”
desc=“Calculation of tides”
        <param name=“day” type=“digits”>Key a day number
followed by the hash symbol.</param>
      </action>
    </choice>
    <choice dtmf=“2”>
      <label>Press 2 to be re-routed to weather forecast
for the Cotes d'Armor</label>
      <transfer dest=“phone://0892680222”/>
    </choice>
    <choice dtmf=“3”>
      <label>Press 3 to consult further SVIP
service</label>
      <gosub src=“svip://1011”/>
    </choice>
    <choice dtmf=“4”>
      <label>Press 4 for a content from the SVIP 10
11</label>
      <gosub src=“svip://1011#input_menu:3”/>
    </choice>
    <return dtmf=“*”>
      <label>Press star to exit</label>
    </return>
  </menu>
  <menu id=“main_menu”>
    <welcome>Main menu.</welcome>
    <goodbye>You are exiting the main menu.</goodbye>
    <choice dtmf=“1”>
      <label>Press 1 for the description of the
service</label>
      <data>This service illustrates all the possibilities
of SVML.</data>
    </choice>
    <choice dtmf=“2”>
      <label>Press 2 for contents of the service</label>
      <gosub src=“#internal_contents”/>
    </choice>
    <choice dtmf=“3”>
      <label> Press 3 for contents of other
services</label>
      <gosub src=“#external_contents”/>
    </choice>
    <choice dtmf=“4”>
      <label>Press 4 to hang up immediately</label>
      <exit/>
    </choice>
    <return dtmf=“*”>
      <label>Press star to exit</label>
    </return>
  </menu>
</svml>
```

1-19. (canceled)

20. A method of accessing from a user terminal voice services executed in a first language in an interactive voice server, said method comprising in a platform communicating with said vocal server:
networking voice services written in a second language by using identifiers included in voice services and relating to portions of other voice services and by using returns to said voice services respectively included in said portions of other voice services,
converting any voice service called up from said terminal via said voice server and written in said second language into said first language in said platform, transmitting said any voice service converted into said first language from said platform to said voice server, and
executing said any voice service converted into said first language in said voice server, and
converting into said first language in said platform any portion of another voice service identified in said any voice service called up during the execution of said any voice service and written in said second language, transmitting said any voice service portion converted into said first language from said platform to said voice server, and executing said any voice service portion converted into said first language in said voice server.

21. A method according to claim 20, wherein said voice services are performed on a plurality of platforms, causing communicating of the two platforms with each other if at least a portion of a voice service performed on one of said two platforms is identified and called up by another service performed on the other of said two platforms.

22. A method according to claim 20, comprising introducing from an administrator terminal into a voice service written in said second language an attribute having two values that respectively authorize and prohibit calling up at least a portion of said voice service from within another voice service.

23. A method according to claim 20, comprising introducing the identifier of at least a portion of another voice service from an administrator terminal into a voice service written in said second language.

24. A method according to claim 23, wherein said portion of another voice service is one of (a) said other voice services, (b) a submenu in said other voice services, and (c) a choice of submenus in said other voice services.

25. A method according to claim 20, comprising introducing from an administrator terminal an identifier of one of a text file which is to be synthesized into a voice file in said interactive voice server and a sound file which is read in said administrator terminal into a voice service in said second language.

26. A method according to claim 25, further including storing said one file on said platform.

27. A method according to claim 20, comprising introducing from an administrator terminal into a voice service in said second language one of (a) an address of a text file which is to be synthesized in the form of a voice file in said voice server, and (b) an address of a sound file, said file being available on a remote other platform.

28. A method according to claim 20, comprising supplying from an administrator terminal a summary of one of (a) a vocal service, and (b) a textual voice service to be subsequently synthesized to said platform.

29. A method according to claim 20, comprising introducing into said any voice service start and end of validity dates between which data of said any voice service is accessible on said platform to said user terminal via said voice server.

30. A method according to claim 20, comprising associating from an administrator terminal a password with an identifier of said any voice service before said any voice service published in said administrator terminal is saved in said second language on said platform.

31. A method according to claim 20, comprising performing a prior authorization to consult said any voice service on said platform if said platform finds a secret code of said any voice service transmitted by said user terminal via said voice server in corresponding relationship with an identifier of said any voice service transmitted by said user terminal via said voice server.

32. A method according to claim 20, comprising performing a prior authorization to consult a voice service on said platform if said platform finds an identifier of said user terminal transmitted by said voice server in corresponding relationship with an identifier of said any voice service transmitted by said user terminal via said voice server.

33. A method according to claim 32, comprising selecting said any voice service from a list of voice services transmitted by said voice server to said user terminal in order for said terminal.

34. A method according to claim 33, further including causing a call-up by said terminal of the selected any voice service by transmitting said identifier of said selected any voice service to said platform via said voice server.

35. A method according to claim 20, comprising recording start and end of consultation of a service portion of said any voice service on said platform.

36. An interactive voice services system, wherein a user terminal is arranged to access voice services executed in a first language in an interactive voice server, said system comprising:
a first platform,
a second platform, and
an administrator terminal,
said first platform being arranged to respond to said administrator terminal publishing an interactive voice service accessible from said user terminal via said interactive voice server on a second platform, and
said first platform being arranged to network voice services written in a second language by using identifiers included in voice services and relating to portions of other voice services and by using returns to said voice services respectively included in said portions of other voice services,
said second platform being arranged to (a) convert into said first language any voice service called up from said terminal via said voice server and written in said second language, (b) transmit said any voice service converted into said first language from said platform to said voice server, and (c) execute said any voice service converted into said first language in said voice server, and
said second platform being arranged to (a) convert into said first language any portion of another voice service identified in said any voice service called up during the execution of said any voice service and written in said second language, (b) transmit said any voice service portion converted into said first language from said platform to said voice server, and (c) execute said any voice service portion converted into said first language in said voice server.

37. A system according to claim 36, wherein said first platform is arranged for establishing a correspondence between passwords of administrators and identifiers of published voice services.

38. A system according to claim 36, wherein said second platform is arranged for establishing a correspondence between identifiers of voice services and portions of voice services and lists of user terminal addresses.

39. A system according to claim 36, wherein said second platform is arranged for associating with an address of a user terminal identifiers of voice services and start and end times of voice services consultation by said user terminal.

40. A system according to claim 36, wherein said first platform and second platform are combined in one and the same platform.
